(19) United States
(12) Patent Application Publication
(10) Pub. No.: US 2008/0077723 A1
(43) Pub. Date: Mar. 27, 2008

(54) COMPUTER SYSTEM INCLUDING DEVICE CONDUCTING INDEPENDENT SYSTEM MANAGEMENT OPERATION AND CONTROL METHOD THEREOF

(75) Inventor: Dong-geun LEE, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/755,327

(22) Filed: May 30, 2007

(30) Foreign Application Priority Data
Sep. 22, 2006 (KR) 2006-92366

(51) Int. Cl. G06F 13/24

(52) U.S. Cl. 710/261

(57) ABSTRACT

A computer system and a control method thereof are provided. The computer system includes an interrupt generator which responds to a system management event to generate an interrupt; a processor which stores a state of an operating system (OS) which is being executed, and enters a system managing mode if the interrupt is input when executing an order of an operating system (OS); and at least one IO device which receives the interrupt from the interrupt generator, and conducts a predetermined system management operation corresponding to the interrupt. Thus, the present invention provides a computer system and a control method thereof improving reliability and stability of system management, and improving system performance.

### CROSS-REFERENCE TO RELATED APPLICATIONS

This application claims all benefits accruing under 35 U.S.C. §119 from Korean Patent Application No. 2006-92366, filed on Sep. 22, 2006, in the Korean Intellectual Property Office, the disclosure of which is incorporated herein by reference.

### BACKGROUND OF THE INVENTION

1. Field of the Invention

The present invention relates to a computer system, and more particularly, relates to a computer system and a control method operable in a system managing mode.

2. Related Art

Generally, a computer system 1, as shown in FIG. 1, includes a processor, i.e., a central processing unit (CPU) 11, a north bridge 12 and a south bridge 13 which are coupled to a host bus (not shown). The north bridge 12 connects the CPU 11, a graphics/display subsystem 14 and a main memory 15 together. The south bridge 13 includes a peripheral bus, such as, a peripheral component interconnect (PCI) bus, a low pin count (LPC) bus, etc., and connects peripheral devices, such as, a PCI device 16, a flash memory 17 which stores a system basic input/output start-up instructions (BIOS), a microcomputer 18, etc. together. The PCI device 16 includes a sound card, a modem, a network card, etc. The microcomputer 18 conducts a system management, and manages additional operations such as a thermal monitor operation, a power operation, etc. through a thermal monitor sensor 19, a battery 20, etc. That is, the microcomputer 18 completes operations about system information which an operating system (OS) requires, and transmits the results thereof to the operating system (OS) installed in the main memory 15.

A typical system management operation in such a computer system 1, as shown in FIG. 1, will be described as follows. At first, the operating system (OS) requests predetermined data related to a system (below, referred to “system data”) stored in a system basic input/output start-up instructions (system BIOS) stored in the flash memory 17. If the system data is capable of being directly obtained by the BIOS in the flash memory 17, the BIOS directly communicates with the operating system (OS).

However, if the system data (such as “battery information”, “temperature information”, etc.,) is obtained, via the microcomputer 18, a system management mode (herein referred to as “SMM”) is employed. The system management mode is one of an operating mode supported by any one of Intel 386™, i486, Celeron™ or Pentium7 processors as marketed by Intel7 Corporation. In the system management mode, all normal executions including operation of the operating system (OS) are suspended, and a predetermined specific order is executed according to an interrupt. SMM may be triggered by an independent event or when the processor requests certain read/write operations from designated input/output (IO) devices.

Referring to FIG. 1, if a system management interrupt (SMI) occurs, the south bridge 13 asserts an SMI# pin provided to the CPU 11. Accordingly, the CPU 11 enters into a system management mode (SMM) from a protected mode or a real-address mode in which the operating system (OS) is operated. If the SMM is entered, the CPU 11 stores a current state of a processor in a system management RAM (SMRAM), and executes an SMI handler code (herein referred to “SMM code”) provided to a predetermined area of the SMRAM. Generally, the SMM code is stored in the flash memory 17, and is loaded into the SMRAM by the BIOS during system booting (start up).

If the SMM code is executed, the CPU 11 confirms an SMI cause, and informs the microcomputer 18 that the SMM is entered. Accordingly, the microcomputer 18 stores a current state such as value of a register related to the operating system (OS), etc. in a predetermined memory.

Then, the BIOS receives system data from the microcomputer 18, and stores the same in a predetermined area of the memory unit 15. After this, by execution of the SMM code, the microcomputer 18 is informed that the SMM is ended, and the microcomputer 18 restores the register related to the operating system (OS) based on the stored value of the register related to the operating system (OS).

Then, the south bridge 13 sets an end of SMI (EOS) to de-assert the SMI#. Accordingly, the CPU 11 reads the state stored in the SMRAM to restore the previous state, and the operating system (OS) resumes operation. The operating system (OS) obtains the system data stored in a specific area of the memory unit 15.

As described in connection with FIG. 1, to obtain the system data from an input/output (IO) device or a peripheral device, such as the microcomputer 18, by using the SMM, the peripheral device should be informed that the CPU 11 enters the SMM so that the peripheral device can store current data. Since the peripheral device, such as the microcomputer 18, is communicating with a device driver of the operating system (OS) just prior to entering the SMM, such a peripheral device may malfunction, particularly, if information related to the SMM is suddenly input during such a communication.

However, in a typical computer system 1, as shown in FIG. 1, since the SMI# pin is provided to only the CPU 11, and if the SMI occurs, the CPU 11 should separately inform the peripheral device whether the CPU 11 has entered the SMM by a predetermined method. Generally, since the peripheral device informing operation is executed by the SMM code, a stay time in the SMM becomes prolonged. If the stay time in the SMM is prolonged, system performance becomes less reliable and may decrease. In terms of hardware, there is no system performance difference. However, in terms of software, since the SMM is an additional operation which the operating system (OS) can not recognize, the system performance may decrease.

### SUMMARY OF THE INVENTION

Several aspects and example embodiments of the present invention provide a computer system and a control method thereof improving reliability and stability of a system management, and improving a system performance, and a power management of a peripheral device or an IO device.

Another aspect of the present invention is to provide a computer system and a control method thereof improving a system performance such as stability of an operating system (OS) by efficiently executing an operation independent of a state of an operating system (OS) as an operation of an IO device necessary for reliability and stability of a system management.

Still another aspect of the present invention is to provide a computer system and a control method thereof more dynamically converted into an SMM to minimize poor system performance such as an operation of an operating system (OS) due to an SMM operation.

Additional aspects of the present invention will be set forth in part in the description which follows and, in part, will be obvious from the description, or may be learned by practice of the present invention.

In accordance with an example embodiment of the present invention, a computer system comprises: an interrupt generator which generates an interrupt in response to a system management event; a processor which stores a state of an operating system (OS) which is being executed, and enters into a system managing mode if the interrupt is input when executing an order of an operating system (OS); and at least one input/output (IO) device which receives the interrupt from the interrupt generator, and conducts a predetermined system management operation corresponding to the interrupt.

According to an aspect of the present invention, the interrupt comprises a system management interrupt (SMI), and the system managing mode comprises a system management mode (SMM).

According to an aspect of the present invention, the system management operation comprises at least one of power management and thermal monitoring operations.

According to an aspect of the present invention, the processor executes a predetermined SMM code if the interrupt is input, and the IO device stores an operation state related to the operating system (OS), and conducts a preparing operation of communication by means of execution of SMM code if the interrupt is input.

According to an aspect of the present invention, the operation state related to the operating system (OS) comprises value about at least one of a register and an I/O port related to the operating system (OS).

According to an aspect of the present invention, if the SMM is ended, the interrupt generator informs the processor and the IO device of the end of the SMM, and the IO device conducts a restoring operation based on the stored operation state related to the operating system (OS) if the IO device is informed of the end of the SMM by the interrupt generator.

According to an aspect of the present invention, the IO device enters a power saving mode upon receipt of the interrupt under a normal mode.

According to an aspect of the present invention, the power saving mode comprises state D2 or state D3 based on an advanced configuration power interface (ACPI).

According to an aspect of the present invention, if the SMM is ended, the interrupt generator informs the processor and the IO device of the end of the SMM, and the IO device is restored from the power saving mode to the normal mode if the IO device is informed of the end of the SMM by the interrupt generator.

In accordance with another example embodiment of the present invention, a control method of a computer system comprising a processor and at least one IO device, comprising: generating an interrupt with respect to a system management event, and inputting the interrupt to the processor and the IO device; storing a state of an operating system (OS) which is being executed at the processor, and entering the processor into a system managing mode if the interrupt is input when executing an order of an operating system (OS) at the processor; and receiving the interrupt at the IO device and conducting a predetermined system management operation corresponding to the interrupt at the IO device.

According to an aspect of the present invention, the interrupt comprises a system management interrupt (SMI), and the system managing mode comprises a system management mode (SMM).

According to an aspect of the present invention, the system management operation comprises at least one of a power management operation and a thermal monitor operation.

According to an aspect of the present invention, the system managing mode entering stage comprises executing a predetermined SMM code if the interrupt is input in the processor, and the system management operation conducting stage comprises storing an operation state related to the operating system (OS), and conducting a preparing operation of communication by means of execution of the SMM code if the interrupt is input in the IO device.

According to an aspect of the present invention, the operation state related to the operating system (OS) comprises value about at least one of a register and an I/O port related to the operating system (OS).

According to an aspect of the present invention, the control method of the computer system further comprises informing the processor and the IO device of an end of the SMM if the SMM is ended, and the system management operation conducting stage comprises conducting a restoring operation based on the stored operation state related to the operating system (OS) at the IO device if the IO device is informed of the end of the SMM.

According to an aspect of the present invention, the system management operation conducting stage comprises entering a power saving mode at the IO device if the IO device is input by the interrupt under a normal mode.

According to an aspect of the present invention, the power saving mode comprises state D2 or state D3 based on an advanced configuration power interface (ACPI).

According to an aspect of the present invention, the control method of the computer system further comprises informing the processor and the IO device of an end of the SMM if the SMM is ended, and the system management operation conducting stage comprises restoring from the power saving mode to the normal mode at the IO device if the IO device is informed of the end of the SMM.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram illustrating a configuration of a typical computer system;

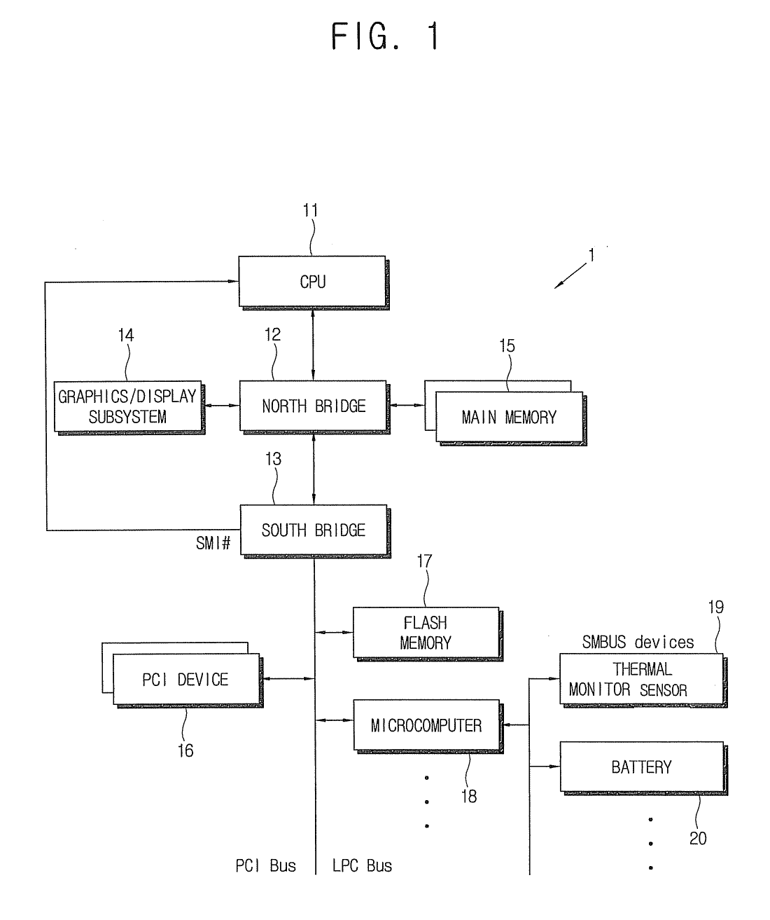

FIG. 2 is a block diagram illustrating a configuration of a computer system according to an example embodiment of the present invention;

FIG. 3 is a flowchart illustrating an operation of the computer system according to an example embodiment of the present invention; and

FIG. 4 is a flowchart illustrating an operation of a computer system according to another example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to like elements throughout. The embodiments are described below in order to explain the present invention by referring to the figures.

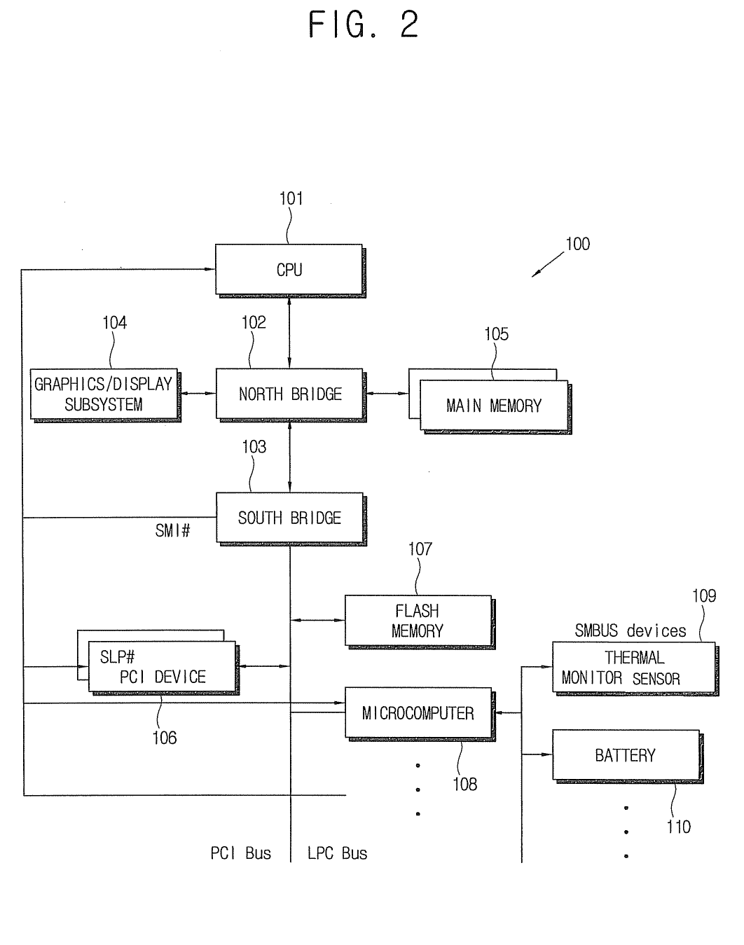

FIG. 2 is a block diagram illustrating a configuration of a computer system according to an example embodiment of the present invention. As shown in FIG. 2, a computer system 100 comprises a CPU 101, a north bridge 102 and a south bridge 103 which are coupled to a host bus (not shown). The north bridge 102 connects the CPU 101, a graphics/display subsystem 104 and a main memory 105 together.

The CPU 101 is typically a commercially available processor, such as the PENTIUM microprocessor from the Intel Corporation, PowerPC microprocessor, SPARC processor, PA-RISC processor, M68000 series microprocessor or MIPS processor. Many other processors are available.

The graphics/display subsystem 104 may include, for example, a graphics controller or an accelerated graphics port (AGP) graphic card, a local memory and a display monitor (e.g., cathode ray tube “CRT” monitor, liquid crystal display “LCD” monitor, and flat panel display “FPD” monitor). The main memory 105 may correspond to a dynamic random-access-memory (DRAM), but may be substituted for read-only-memory (ROM), video random-access-memory (VRAM), synchronous dynamic random-access-memory (SDRAM) and the like. Such a memory 105 may include a non-volatile memory such as a read-only-memory (ROM) which stores an operating system (OS) for use by the CPU 101, and a volatile memory such as a random-access-memory (RAM) or a static random-access-memory (SRAM) which stores temporary information for use by the CPU 101. The operating system (OS) may include any type of OS, including, but not limited to, Berkeley Software Development, Inc (BSDI) O.S. (Unix-based), Microsoft Disk Operating System (DOS), Apple Macintosh OS, WINDOWS 95, WINDOWS 98, WINDOWS NT, SYSTEM 7, SOLARIS, Novell NetWare, InternetWare, IRIX, or AT&T UNIX operating system (WINDOWS is a registered trademark of the Microsoft Corporation, SYSTEM 7 is a registered trademark of the Apple Corporation, Solaris is a registered trademark of Sun Microsystems, Inc., IRIX is a trademark of the Silicon Graphics Corporation, MIPS is a registered trademark of MIPS Technologies, Inc., and NetWare and InternetWare are registered trademarks of the Novell Corporation), for use by the CPU 101.

The south bridge 103 serves as an input/output (IO) controller hub to provide an interface to a variety of IO devices and the like, including a peripheral bus, such as, a peripheral component interconnect (PCI) bus (PCI Local Bus Specification Revision 2.2 as set forth by the PCI Special Interest Group (SIG) on Dec. 18, 1998), to support one or more peripheral devices, such as a PCI device 106, and a low pin count (LPC) bus to support, for example, a flash memory 107, and a microcomputer 108.

The south bridge 103 includes a SMI port (not shown), and asserts an SMI# if a predetermined event related to a system (also, referred to “system management event”), that is, an SMI occurrence. Also, the south bridge 103 de-asserts the SMI# if a system management mode (SMM) is ended. According to an example embodiment of the present invention, the south bridge 103 serves as an example of an interrupt generator. However, other components can also serve as an interrupt generator.

The PCI device 106 includes a sound card, a modem, a network interface card (NIC), an answering machine, a scanner, a personal digital assistant (PDA) etc.

The flash memory 107 (e.g., ROM and EEPROM) may contain a set of system basic input/output start-up instructions (system BIOS) as well as other applications that may execute during boot up (start-up) before the operating system (OS) is loaded, including power saving instructions for full-on, standby and sleep states in accordance with the Advanced Power Management (APM) specification and/or the Advanced Configuration and Power Interface (ACPI) specification. The system BIOS that is encoded in the flash memory 107 also includes runtime code (initialization, configuration and parameter) code tables (not shown) which contain all configuration information necessary to configure a variety of I/O devices connected to the computer system 100. Alternatively, the system BIOS and ACPI power saving instructions may also be encoded in the non-volatile memory (ROM) of the main memory 105 along with the operating system (OS).

The microcomputer 108 conducts a system management. The microcomputer 108 conducts additional operations such as a thermal monitor operation, a power management operation, etc. through a thermal monitor sensor 109, a battery 110, etc. That is, the microcomputer 108 completes an operation about a system information which an operating system (OS) requires, and transmits the result thereof to the operating system (OS).

According to an example embodiment of the present invention, a peripheral device such as the PCI device 106, the microcomputer 108, etc. (below, referred to “IO device”) as well as the CPU 101 includes an input port for receiving an SMI# signal of the south bridge 103. The input ports of these IO devices are connected to the south bridge 103 to receive the SMI# signal of the south bridge 103. The CPU 101 is an example of a processor used according to an embodiment of the present invention, and the peripheral device, such as the PCI device 106 and the microcomputer 108 is an example of an IO device according to an embodiment of the present invention. In addition, the north bridge 102 and the south bridge 103 may be implemented along with a firmware hub on a single host chipset. Graphics/display subsystem 104 may even be incorporated into the north bridge 102 for enhanced functionality.

An IO device according to an example embodiment of the present invention can also be any device cooperating with the BIOS stored in the flash memory 107 for the system management. For example, the microcomputer 108 is directly informed whether the CPU 101 enters the SMM or not by the SMI# signal of the south bridge 103 if the SMM is entered. Accordingly, the microcomputer 108 can independently and smoothly conduct a system management operation without executing an SMM code.

The microcomputer 108 may include separate hardware logic for a mode conversion to the SMM by the SMI# signal of the south bridge 103. If the SMI# signal is input by the south bridge 103, the microcomputer 108 stores information about a register, an I/O port, etc. for communication with the BIOS. After this, if the SMI# is de-asserted, the microcomputer 108 restores the register, the I/O port, etc. based on the stored information.

For another example embodiment, an SMI# signal output port of the south bridge 103 may be connected to a sleep signal input port of the IO device (referring to a SLP#). For example, the PCI device 106 is directly informed through a SLP# if the SMM is entered. Accordingly, if the CPU 101 enters the SMM, the PCI device 106 is converted from state “D0” to state “D2” or state “D3” (referring to an Advanced Configuration Power Interface (ACPI) specification). Since the PCI device 106 operates in connection with the operating system (OS), the PCI device 106 is dynamically converted to a power saving mode, for example, the state “D2” or the state “D3” under the SMM at which the operating system (OS) does not operate, thereby improving a power management.

The computer system 100 may further comprise a hardware blocking logic (not shown) for preventing communication between the south bridge 103 and the CPU 101 from being interrupted, or one or more transistors (not shown) arranged for harmonizing an operation voltage.

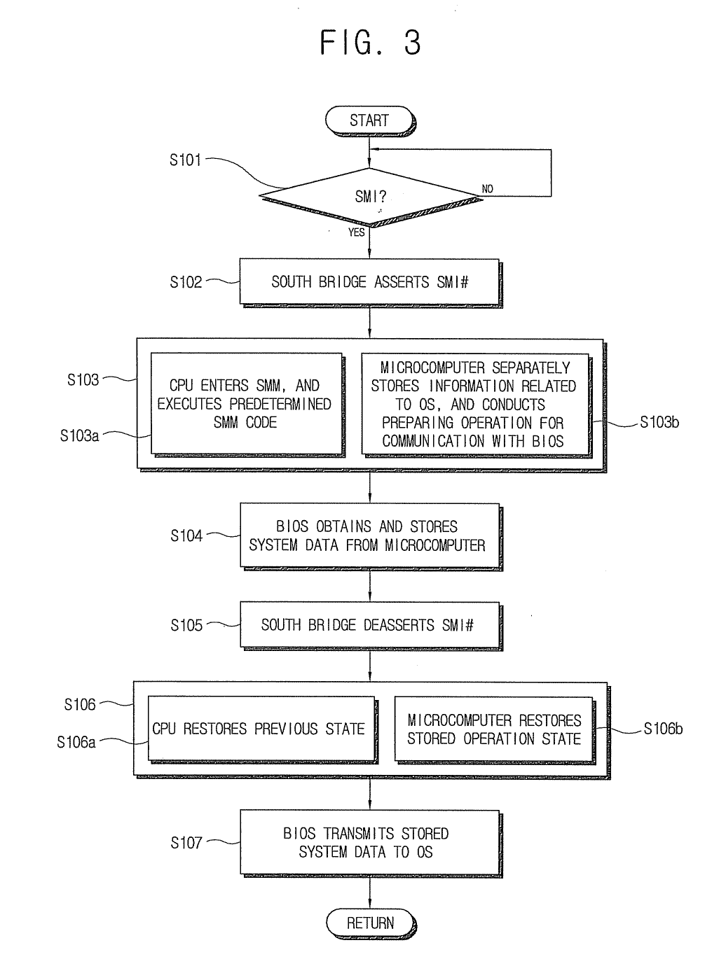

Turning now to FIG. 3, an operation of the computer system 100 according to an example embodiment of the present invention is illustrated. At first, under a state in which an operating system (OS) is operated by the CPU 101, for example, under a protected mode, the south bridge 103 determines whether there is an occurrence of a system management interrupt (SMI) at block S101. If the SMI is determined to occur, the south bridge 103 asserts an SMI# at block S102. Accordingly, the SMI# is input to both the CPU 101 and a designated IO device, i.e., the microcomputer 108 connected to the south bridge 103.

Then, at block S103, the CPU 101 stores a current state in a predetermined area of a system management RAM (SMRAM), and enters the SMM to execute a predetermined SMM code at sub-block S103a. On the other hand, independently of operation of the CPU 101, the microcomputer 108 stores a current state related to the operating system (OS), and conducts preparing operation for communication with the BIOS stored in the flash memory 107 by execution of the SMM code at block S103b. For example, the microcomputer 108 stores information about a register, an I/O port, etc. related to an operating system (OS), and prepares to communicate with the BIOS stored in the flash memory 107.

Then, the BIOS stored in the flash memory 107 obtains system data from the microcomputer 108, and stores the system data in a predetermined area of the main memory 105 at block S104. Then, if the SMM is ended, the south bridge 103 de-asserts the SMI# at block S105. Accordingly, at block S106, the CPU 101 reads a stored state in the SMRAM, and restores a previous state at sub-block S106a. Accordingly, an operating system (OS) resumes operation under the same state as a previous state. In addition, the microcomputer 108 restores the register, the I/O port, etc. based on the stored operation state (OS) at block S106b. The BIOS transmits the system data stored in the predetermined area of the main memory 105 to the operating system (OS) so that the operating system (OS) can use the system data at block S107.

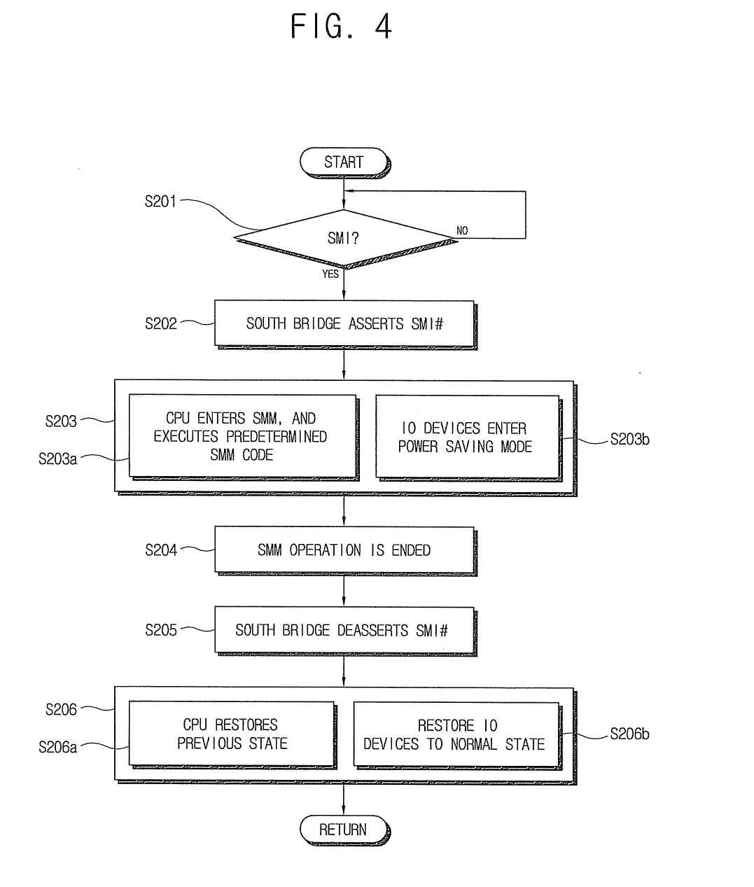

FIG. 4 is a flowchart illustrating an operation of a computer system according to another example embodiment of the present invention. At first, block S201 is the same as block S101, shown in FIG. 3. At block S202, if there is an occurrence of SMI, the south bridge 103 asserts a SMI#. Here, the SMI# is input to a CPU 101 as well as a sleep signal input port of an IO device which is capable of managing power at block S202. For example, the PCI device (106) receives a SMI# signal through a SLP#.

Then, at block S203, sub-block S203a is the same as sub-block S103a, shown in FIG. 3. On the other hand, independently of operation of the CPU 101, the IO device converts from a normal mode to a power saving mode at sub-block S203b. For example, the PCI device 106 is converted from state “D0” to state “D2” or state “D3” in accordance with the Advanced Power Management (APM) specification and/or the Advanced Configuration and Power Interface (ACPI) specification.

Then, if the SMM is ended at block S204, the south bridge 103 de-asserts the SMI# at block S205. Then, at block S206, sub-block S206a is the same as sub-block S106a. On the other hand, the IO device is restored from the power saving mode back to the normal mode at sub-block S206b. For example, the PCI device 106 is restored from state “D2” or state “D3” to state “D0” in accordance with the Advanced Power Management (APM) specification and/or the Advanced Configuration and Power Interface (ACPI) specification.

At blocks S101 to S107 and S201 to S206, except the same sub-blocks, any block of an example embodiment shown in FIG. 3 may be added to an example embodiment shown in FIG. 4, or vice versa. For example, blocks S103b, S104, S106b and S107 may be added to blocks S201 to S206.

As described above, the present invention provides a computer system and a control method thereof improving reliability and stability of system management, and improving system performance. When a SMI# is transmitted both to a CPU as well as an IO device, spurious and inadvertent device communication with an operating system (OS) stored in a main memory 105 and communication with the system BIOS stored in a flash memory 107 can be prevented. On the other hand, by independently conducting a separate operation for communication with the system BIOS without depending on execution of an SMM code when an SMM is entered, execution time of the SMM can be advantageously minimized. Accordingly, system performance can be improved. In addition, by transmitting an SMI# signal to an IO device as well as a CPU, the IO device can be immediately converted from an SMM to a power saving mode, thereby minimizing power consumption.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the control method may be manifest in a combination of hardware, such as transistor control, and software. Such implementation may include a combination of hardware and software on dedicated chips (ASICS, etc.) and various ROMS (ROM, EPROM, EPROM, etc.). Further, software may be written in high-level languages (C, Java, Visual Basic, etc.) to encode the control method and be stored in various media, such as various ROMs and RAM, in addition to being loaded from external media. Accordingly, it is intended, therefore, that the present invention not be limited to the various example embodiments disclosed, but that the present invention includes all embodiments falling within the scope of the appended claims.

What is claimed is:

1. A computer system, comprising:
an interrupt generator to generate an interrupt in response to a system management event;
a processor to store a state of an operating system (OS) which is being executed, and operate in a system managing mode upon receipt of the interrupt; and
at least one IO device to perform a predetermined system management operation upon receipt of the interrupt.

2. The computer system according to claim 1, wherein the interrupt comprises a system management interrupt (SMI), and the system managing mode comprises a system management mode (SMM).

3. The computer system according to claim 1, wherein the system management operation comprises at least one of power management and thermal monitor operations.

4. The computer system according to claim 2, wherein:
the processor executes a predetermined SMM code upon receipt of the interrupt, and
the IO device stores an operation state related to the operating system (OS), and prepares to communicate with a system BIOS by means of execution of SMM code upon receipt of the interrupt.

5. The computer system according to claim 4, wherein the operation state related to the operating system (OS) comprises a value of at least one register and an I/O port related to the operating system (OS).

6. The computer system according to claim 4, wherein, if the SMM is ended, the interrupt generator informs the processor and the IO device of the ending of the SMM, and the device restores operation based on the stored operation state related to the operating system (OS) if the IO device is informed of the end of the SMM by the interrupt generator.

7. The computer system according to claim 2, wherein the IO device enters a power saving mode if the IO device receives the interrupt under a normal mode.

8. The computer system according to claim 7, wherein the power saving mode comprises state “D2” or state “D3” based on an Advanced Configuration Power Interface (ACPI) specification.

9. The computer system according to claim 7, wherein if the SMM is ended, the interrupt generator informs the processor and the IO device of the end of the SMM, and the IO device is restored from the power saving mode to the normal mode if the IO device is informed of the end of the SMM by the interrupt generator.

10. A control method of a computer system comprising a processor and at least one IO device, comprising:
generating an interrupt in response to a system management event, and inputting the interrupt concurrently to the processor and the IO device;
storing a state of an operating system (OS) at the processor which is being executed, and entering the processor into a system managing mode upon receipt of the interrupt; and
conducting a predetermined system management operation corresponding to the interrupt at the IO device upon receipt of the interrupt.

11. The control method according to claim 10, wherein the interrupt comprises a system management interrupt (SMI), and the system managing mode comprises a system management mode (SMM).

12. The control method according to claim 10, wherein the system management operation comprises at least one of power management and thermal monitor operations.

13. The control method according to claim 11, wherein, when the system managing mode is entered, a predetermined SMM code is executed at the processor, and, when the system management operation is conducted, an operation state related to the operating system (OS) is stored, and the SMM code is executed at the IO device.

14. The control method according to claim 13, wherein the operation state related to the operating system (OS) comprises a value of at least one of a register and an I/O port related to the operating system (OS).

15. The control method of the computer system according to claim 13, further comprising:
informing the processor and the IO device of an end of the SMM if the SMM is ended, and
the system management operation conducting stage further comprises conducting a restoring operation based on the stored operation state related to the operating system (OS) at the IO device if the IO device is informed of the end of the SMM.

16. The control method of the computer system according to claim 11, wherein the system management operation conducting stage further comprises entering a power saving mode at the IO device if the IO device receives the interrupt during normal mode operation.

17. The control method according to claim 16, wherein the power saving mode comprises state “D2” or state “D3” based on an Advanced Configuration Power Interface (ACPI) specification.

18. The control method according to claim 16, further comprising:
informing the processor and the IO device of an end of the SMM if the SMM is ended, and
the system management operation conducting stage further comprises restoring from the power saving mode back to the normal mode at the IO device if the IO device is informed of the end of the SMM.

19. A computer system, comprising:
an interrupt generator to generate an interrupt in response to a system management event;
a processor coupled to operate in a system management mode (SMM) upon receipt of the interrupt; and
at least one IO device coupled to receive the interrupt concurrently with the processor, to perform a predetermined system management operation upon receipt of the interrupt.

20. The computer system according to claim 19, wherein the processor is configured to enter into the system management mode (SMM) and execute a predetermined SMM code, while the IO device is configured to separately store a current status of an operating system (OS) stored in a main memory, and communicate with a system BIOS stored in a flash memory.

21. The computer system according to claim 20, wherein the IO device stores information about a register and an IO port related to the operating system (OS) stored in the main memory, and communicates with the system BIOS stored in the flash memory.

22. The computer system according to claim 20, wherein the system BIOS obtains system data from the IO device and stores the system data in a predetermined area in a main memory, and when the interrupt is ended, the processor restores the status of the operating system (OS) and the IO device restores an operating state.

23. The computer system according to claim 19, wherein the processor is configured to enter into the system management mode (SMM) and execute a predetermined SMM code, while the IO device is configured to enter into a power saving mode.

24. The computer system according to claim 23, wherein, when the interrupt is ended, the processor restores the status of the operating system (OS) and the IO device resumes to a normal mode.
